(19) United States
(12) Patent Application Publication
(10) Pub. No.: US 2024/0348065 A1
(43) Pub. Date: Oct. 17, 2024

(54) BATTERY SYSTEM CHARGE LEVEL MANAGEMENT

(71) Applicant: Caterpillar Inc., Peoria, IL (US)

(72) Inventor: Jared J. Brodbeck, Metamora, IL (US)

(73) Assignee: Caterpillar Inc., Peoria, IL (US)

(21) Appl. No.: 18/298,647

(22) Filed: Apr. 11, 2023

(51) Int. Cl. H02J 7/00; H01M 10/44; H01M 10/46; H01M 10/48; H01M 10/63; H01M 10/6571

(52) U.S. Cl. CPC H02J 7/0016; H01M 10/441; H01M 10/46; H01M 10/482; H01M 10/63; H01M 10/6571; H02J 7/0048; H02J 7/007194; B60L 58/22; B60L 2200/40

(57) ABSTRACT

A battery system a first battery module and a second battery module, at least one thermal mat being in thermal contact with at least one battery module, a controller configured to, during a charge cycle, determine that a charge level of the first battery module is out of balance with a charge level of the second battery module and cause a thermal mat to be powered by the first battery module.

### TECHNICAL FIELD

The present disclosure relates to systems configured to improve battery system functionality. More specifically, the present disclosure relates to a thermal management to improve charge level of different modules in a battery system.

### BACKGROUND

Work machines, such as mining trucks, loaders, dozers, compaction machines, or other construction or mining equipment, have been traditionally powered by internal combustion engines. These engines have generally provided power to propulsion system components configured to move the work machine along a travel path, and typically also provide power to an electrical system associated with the work machine. However, the source of power of work machines as well as the use of the electrical systems have evolved. Whereas in the past, combustion engines have been the primary source of motive and electrical power, work machines are increasingly using battery systems which may include multiple battery modules as the primary source of energy, either augmenting an internal combustion system in the case of a hybrid work machine, or supplanting the internal combustion system altogether in the case of an electric, non-hybrid (EV) work machine.

Such battery systems discharge during use and can be charged, or recharged, between or during uses. The discharging and recharging of the systems can result in variability in the charge levels of the battery modules within the battery system. For example, during charging cycles, certain modules may charge faster and achieve a significantly higher charge level than other modules within the battery system. Similarly, during use or discharging, certain modules may discharge faster and achieve a significantly lower charge level than other modules within the battery system. This variability can result in failure to use each charged battery module fully, or failure to completely charge each battery module in the battery system.

Examples of the present disclosure are directed to overcoming deficiencies of such systems.

### SUMMARY

In one aspect of the present disclosure, a system includes a battery module, the battery module comprising, a first battery module being in thermal contact with and configured to power a first thermal mat, a second battery module being in thermal contact with and configured to power a second thermal mat, a thermal controller configured to, during a charge cycle determine that a charge level of the first battery module is out of balance with a charge level of the second battery module and cause the first thermal mat to be powered by the first battery module to discharge the first battery module.

In another aspect of the present disclosure, a work machine includes an electric motor and a battery system powering the electric motor, the battery system comprising a plurality of battery modules, each battery module comprising a plurality of battery cells, a plurality of thermal mats, each thermal mat in thermal contact with and powered by an associated battery module of the plurality of battery modules, and a system-wide thermal controller configured to, during a charge cycle, cause a selected thermal mat of the plurality of thermal mats to be powered by the associated battery module to discharge the associated battery module when the thermal controller determines a charge level of the associated battery module is out of balance with at least one other battery module of the plurality of battery modules.

In a still further aspect of the present disclosure, a method includes starting a charge cycle for a battery system having a plurality of battery modules, each module being in contact with and powering a corresponding thermal mat, determining that a charge level of a first battery module of the plurality of battery modules is out of balance with a second battery module of the plurality of battery modules, causing the first battery module to power the thermal mat corresponding to the first battery module to discharge the first battery module.

### BRIEF DESCRIPTION OF DRAWINGS

FIG. 1 is a schematic illustration of an example work machine that travels over a surface, in accordance with examples of the disclosure.

FIG. 2 is schematic illustration of a battery system used to power systems of a work machine, such as a motor, in accordance with one or more examples of the presently disclosed subject matter.

FIG. 3 is a schematic illustration of the battery system of FIG. 2, illustrating charge levels of various battery modules during a charge cycle.

FIG. 4 is a schematic illustration of the battery system of FIGS. 2 and 3, illustrating charge levels of various battery modules during a charge cycle with charge-level management in accordance with examples described herein.

FIG. 5 is a flowchart illustrating a method of managing charge levels of battery modules in a battery system used to power systems of a work machine, according to examples of this disclosure.

### DETAILED DESCRIPTION

Systems and technologies described below are directed to battery system charge-level management systems. Wherever possible, the same reference numbers will be used throughout the drawings to refer to the same or like parts.

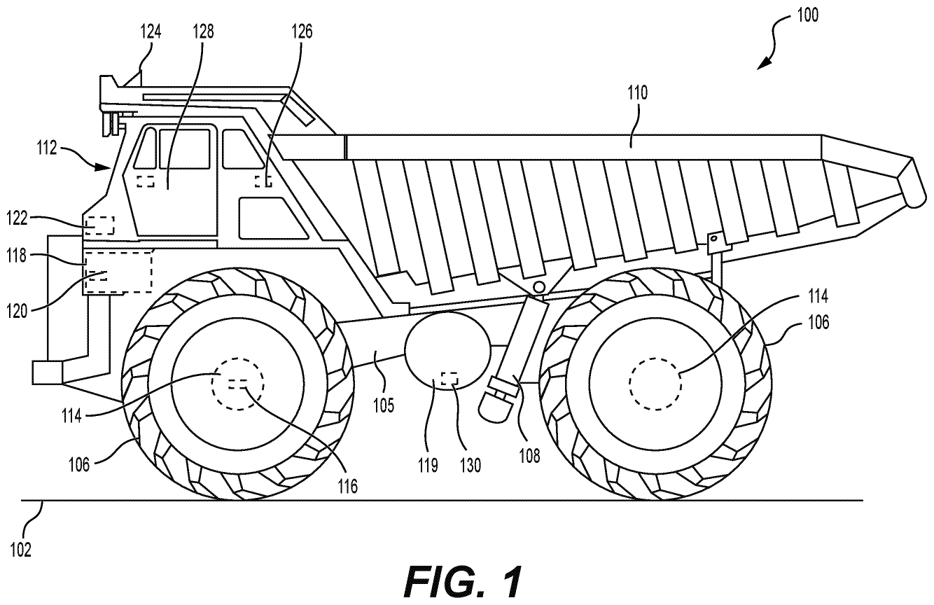

FIG. 1 is a schematic illustration of an example work machine 100 that travels over a surface 102, in accordance with examples of the disclosure. The work machine 100, although depicted as a mining truck type of machine, may be any suitable machine, such as any type of loader, dozer, dump truck, skid loader, excavator, compaction machine, backhoe, combine, crane, drilling equipment, tank, trencher, tractor, any suitable stationary machine, any variety of generator, locomotive, marine engines, combinations thereof, or the like. In some examples, the work machine can be a hybrid system, an electric vehicle (no internal combustion engine), or use internal combustion as the primary source of energy. The presently disclosed subject matter is not limited to any particular platform of use and may be implemented across various types of vehicles, installations (e.g., non-vehicle uses), and the like. The work machine 100 of FIG. 1 is merely for purposes of illustration.

As shown in FIG. 1, the work machine 100 includes a frame 105 and wheels 106. The wheels 106 are mechanically coupled to a drive train (not shown) to propel the work machine 100. When the wheels 106 of the work machine 100 are caused to rotate, the work machine 100 traverses the surface 102. Although illustrated in FIG. 1 as having a hub with a rubber tire, in other examples, the wheels 106 may instead be in the form of drums, chain drives, combinations thereof, or the like. The frame 105 of the work machine 100 is constructed from any suitable materials, such as iron, steel, aluminum, other metals, ceramics, plastics, the combination thereof, or the like. The frame 105 is of a unibody construction in some cases, and in other cases, is constructed by joining two or more separate body pieces. Parts of the frame 105 are joined by any suitable variety of mechanisms, including, for example, welding, bolts, screws, other fasteners, epoxy, combinations thereof, or the like.

The work machine 100 may include a hydraulic system 108 that move a dump box 110 or other moveable elements configured to move, lift, carry, and/or dump materials. The dump box 110 is used, for example, to pick up and carry dirt or mined ore from one location on the surface 102 to another location of the surface 102. The dump box 110 is actuated by the hydraulic system 108, or any other suitable mechanical system. In some cases, the hydraulic system 108 is powered by an electric motor (not shown), such as by powering hydraulic pump(s) (not shown) of the hydraulic system 108. It should be noted that in other types of machines (e.g., machines other than a mining truck) the hydraulic system 108 may be in a different configuration than the one shown herein, may be used to operate elements other than a dump box 110, and/or may be omitted.

With continued reference to FIG. 1, the work machine 100 also includes an operator station 112. The operator station 112 is configured to seat an operator (not shown) therein. The operator seated in the operator station 112 interacts with various control interfaces and/or actuators within the operator station 112 to control movement of various components of the work machine 100 and/or the overall movement of the work machine 100 itself. Thus, control interfaces and/or actuators within the operator station 112 allow the control of the propulsion of the work machine 100 by controlling operation of one or more motors 114 that are electric motors, the motors 114 being controlled by a motor controller 116 and powered by a battery system 118. The battery system 118 includes one or more battery modules, each module having one or more cells that, when electrically connected, provide a battery. The motor controller 116 may be controlled according to operator inputs received at the operator station 112. A battery system controller 120 monitors and controls various aspects of the battery system 118, such as controlling a temperature of the battery system 118 or the battery modules, or management of the charge levels of the battery system 118 or the battery modules.

The motors 114 may be of any suitable type, such as induction motors, permanent magnet motors, switched reluctance (SR) motors, combinations thereof, or the like. The motors 114 are of any suitable voltage, current, and/or power rating. The motors 114 when operating together are configured to propel the work machine 100 as needed for tasks that are to be performed by the work machine 100. For example, the motors 114 may be rated for a range of about 500 volts to about 3000 volts. The motor controller 116 includes control electronics configured to control the operation of the motors 114. In some cases, each motor 114 may be controlled by its own motor controller 116. In other cases, all the motors of the work machine 100 may be controlled by a single motor controller 116. The motor controller 116 may further include one or more inverters or other circuitry to control the energizing of magnetic flux generating elements (e.g., coils) of the motors 114. The motors 114 are mechanically coupled to a variety of drive train components, such as a drive shaft and/or axles or directly to the wheels 106 to rotate the wheels 106 and propel the work machine 100.

The drivetrain includes any variety of other components including, but not limited to a differential, connector(s), constant velocity (CV) joints, etc. Although not shown here, there may be one or more motors 114 that are not used for propulsion of the work machine 100, but rather to operate pumps and/or other auxiliary components, such as to operate the hydraulic systems 108. According to examples of the disclosure, the power to energize the motors 114 is received from the battery system 118. It should be noted that, in some cases, the battery system 118 may provide power for operating the motors 114 and/or other power consuming components (e.g., controllers, cooling systems, displays, actuators, sensors, etc.) of the work machine 100. As noted above, the presently disclosed subject matter is not limited solely to the use of battery power, as other forms of energy may be used in conjunction with the power provided by the battery system 118, including, but not limited to, internal combustion engines or fuel cells.

The battery system 118 may be of any suitable type and capacity. For example, the battery module can be a lithium ion battery, a lead-acid battery, an aluminum ion battery, a flow battery, a magnesium ion battery, a potassium ion battery, a sodium ion battery, a metal hydride battery, a nickel metal hydride battery, a cobalt metal hydride battery, a nickel-cadmium battery, a wet cell of any type, a dry cell of any type, a gel battery, combinations thereof, or the like. The battery system 118 may be organized as a collection of electrochemical cells arranged to provide the voltage, current, and/or power requirements of the motors 114. In some cases, the energy capacity of the battery system 118 relative to the energy available from a full fuel tank 119 may be in the range of about 0.2 to about 1.5. In other cases, the energy capacity of the battery system 118 relative to the energy available from a full fuel tank 119 may be in the range of about 0.5 to about 1. In still other cases, the energy capacity of the battery system 118 relative to the energy available from a full fuel tank 119 may be in the range of about 0.7 to about 0.9. It should be understood that the aforementioned ratios are examples, and the disclosure contemplates the battery system 118 energy capacity to the fuel tank 119 energy capacity ratios in ranges outside of the aforementioned ranges.

The work machine 100 includes an electronic control module (ECM) 122 that controls various aspects of the work machine 100. The ECM 122 is configured to receive battery status (e.g., state-of-charge (SOC) or other charge related metrics) from the battery system controller 120, fuel level from the fuel tank controller 130, operator signal(s), such as an accelerator signal, based at least in part on the operator's interactions with one or more control interfaces and/or actuators of the work machine 100. In other cases, the ECM 122 may receive control signals from a remote-control system by wireless signals received via an antenna 124. The ECM 122 uses the operator signal(s), regardless of whether they are received from an operator in the operator station 112 or from a remote controller, to generate command signals to control various components of the work machine 100. For example, the ECM 122 may control the motors 114 via the motor controller 116, the hydraulic system 108, and/or steering of the work machine 100 via a steering controller 126. It should be understood that the ECM 122 may control any variety of other subsystems of the work machine 100 that are not explicitly discussed here to provide the work machine 100 with the operational capability discussed herein.

The ECM 122, according to examples of this disclosure, may be configured to provide an indication of remaining energy to operate the work machine 100 on an energy gauge 128. The energy gauge 128, according to examples of the disclosure, may be configured to display the amount of energy available to operate the work machine 100 based at least in part on the amount of charge remaining in the battery system 118. In some cases, the energy gauge 128 may provide an indication of an estimated amount of time the work machine 100 can be operated and/or an estimated amount of range the work machine 100 has remaining. These estimates may be generated based on the amount of charge remaining in the battery system 118, the recent usage of energy by the work machine 100, and/or an estimate of the energy expended per unit time (e.g., power requirement) of a task in which the work machine 100 is engaged. The energy gauge 128 may be configured to display, to an operator seated in the operator station 112, the amount of energy, time, and/or range remaining for operating the work machine 100. Additionally or alternatively, the energy gauge 128 and/or the ECM 122 may be configured to indicate, such as wirelessly via the antenna 124, the amount of energy, time, and/or range remaining for operating the work machine 100 to a remote operating system.

The ECM 122 includes single or multiple microprocessors, field programmable gate arrays (FPGAs), digital signal processors (DSPs), and/or other components configured to control the work machine 100. Numerous commercially available microprocessors can be configured to perform the functions of the ECM 122. Various known circuits are operably connected to and/or otherwise associated with the ECM 122 and/or the other circuitry of the work machine 100. Such circuits and/or circuit components include power supply circuitry. inverter circuitry, signal-conditioning circuitry, actuator driver circuitry, etc. The present disclosure, in any manner, is not restricted to the type of ECM 122 or the positioning depicted of the ECM 122 and/or the other components relative to the work machine 100. The ECM 122 is configured to control the use of energy from the battery system 118 in a manner that enhances the range of the work machine 100.

The work machine 100 further includes any number of other components within the operator station 112 and/or at one or more other locations on the frame 105. These components include, for example, one or more of a location sensor (e.g., global positioning system (GPS)), an air conditioning system, a heating system, communications systems (e.g., radio, Wi-Fi connections), collision avoidance systems, sensors, cameras, etc. These systems are powered by any suitable mechanism, such as by using a direct current (DC) power supply powered by the battery system 118.

As noted above, such battery systems discharge during use and can be charged, or recharged, between uses or even during uses. The discharging and recharging of the systems can result in variability in the charge levels of the battery modules within the battery system. For example, during charging cycles, certain modules may charge faster and achieve a significantly higher charge level than other modules within the battery system. Similarly, during use or discharging, certain modules may discharge faster and achieve a significantly lower charge level than other modules within the battery system. This variability can result in failure to use each charged battery module fully, or failure to completely charge each battery module in the battery system.

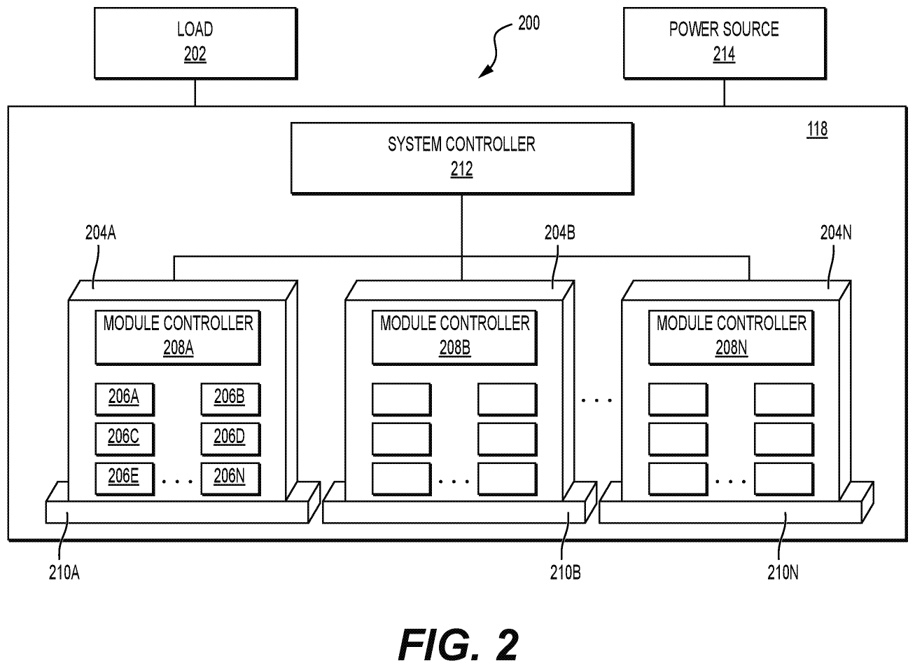

FIG. 2 is a schematic illustration of a power system 200 used to power a load 202, such as systems of a work machine (e.g., a motor), in accordance with one or more examples of the presently disclosed subject matter. The power system 200 includes the battery system 118. The battery system 118 may be of any suitable type and capacity. For example, the battery system 118 may provide one or more types of batteries such as, but not limited to, lithium ion battery, a lead-acid battery, an aluminum ion battery, a flow battery, a magnesium ion battery, a potassium ion battery, a sodium ion battery, a metal hydride battery, a nickel metal hydride battery, a cobalt metal hydride battery, a nickel-cadmium battery, a wet cell of any type, a dry cell of any type, a gel battery, combinations thereof, or the like.

The battery system 118 includes two or more battery modules 204A-204N, referred to herein generically as “the battery modules 204” and individually as “the battery module 204A,” “the battery module 204B,” and the like. Each battery module 204 includes a plurality of cells 206A-206N (referred to herein generically as “the cells 206” and individually as “the cell 206A,” “the cell 206B,” and the like). The cells 206 may have various internal components depending on the particular type of battery module 204 being used. While some battery modules 204 may have the cells 206 arranged in a series or parallel configuration, other battery modules 204 may have a combination of both, called a series/parallel configuration. In various examples, as illustrated in FIG. 2, the battery modules 204, and the one or more cells 206 within the battery module 204, can be electrically coupled to one or more additional battery modules 204 to provide a desired amperage output, a desired voltage output, and/or a desired power output for an external system such as the load 202. For example, the battery module 204A can be configured to nominally output 50.4 volts and can be combined with additional battery modules 204B-204N to provide power to 48-volt nodes, 100-volt nodes, 350-400-volt nodes, 700-750-volt nodes or any other volt nodes. It should be noted that the above numbers are examples and that the individual battery module 204 can be configured to store an amount of amp-hours, discharge an electrical current, and receive an additional electrical current that is defined based at least on an application that the battery system 118 is intended for. Accordingly, the battery system 118 and the battery modules 204 can be configured as a power source for an external system, such as the load 202.

Each battery module 204A-204N is provided with a corresponding module controller 208A-208N. The module controller 208 controls and monitors various parameters related to the battery module 204 and the cells 206 contained therein. In one example, the module controller 208 monitors parameters of the cells 206 such as charge levels, voltage, temperature, etc. The module controller 208 can be provided with functionality which allows the controller 208 to perform load balance or charge balance among the plurality of the cells 208 within each battery module 204.

In some examples, each battery module 204 of the battery system 118 is thermally coupled to a thermal mat 210A-210N. The thermal mats 118 are provided to provide thermal energy to the battery modules 204 to selectively heat the battery modules 204. Such heating may be desirable, for example, when the system 200 has been idle in a cold environment. For example, battery modules 204 may be ineffective or inefficient below a certain temperature. If a work machine containing the system 200 remains idle in a cold, outdoor environment, such as overnight between work shifts, the temperature of the battery modules 204 may drop below a desired threshold. In such cases, one or more thermal mats 210 may be powered to provide heat for the corresponding battery module 204. Thermal coupling of the thermal mats 210 to the corresponding battery module 204, which may include physical coupling, allows heat to be transferred from the thermal mat 210 to the corresponding battery module 204.

In the example illustrated in FIG. 2, each battery module 204 is associated with a corresponding thermal mat 210. In other examples, a thermal mat 210 may be thermally coupled to multiple battery modules 204. For example, each thermal mat 210 may be thermally coupled to two or more battery modules 204. Conversely, each battery module 204 may be thermally coupled to multiple thermal mats 210. For example, each battery module 204 may be thermally coupled to two or more thermal mats 210. The thermal mats 210 may be formed of a variety of materials. In one example, the thermal mats 210 contain heating coils that convert electrical energy into thermal energy which can heat the corresponding battery modules 204. Each thermal mat 210 can be electrically powered by its corresponding battery module 204, by other battery modules 204 within the battery system 118, by a separate power source that is internal to the thermal mat 210, or by a power source that is external to the battery system 118.

The battery system 118 is provided with a system controller 212 to control operation of the battery system 118. The system controller 212 monitors various parameters associated with the battery system 118 and the various battery modules 204 therein. For example, the system controller 212 can monitor such parameters as charge level and temperature of each battery module 204. In addition, the system controller 212 can control operation of each thermal mat 210 in the battery system 212. The system controller 212 may be implemented as hardware, software, firmware, or a combination of any of these.

While the battery system 118, or the battery modules 204 therein, can be used to provide power to the load 202, an external power source 214 can be used to re-charge the battery system 118 and the battery modules 204 therein. The external power source 214 can be an external battery, a generator, a source connected to the electrical grid, or any other source that can be used to charge the battery modules 204. When the charge level of the battery system 118 as a whole or the battery modules 204 drops below a desired value, the battery system 200 may be coupled to the power source 214 to recharge the battery system.

During a recharge cycle, the charging of the battery system 118 results in charge being supplied to the battery modules 204. When one battery module 204 reaches a sufficiently high charge level, that battery module 204 may be considered fully charged. When one battery module 204 is fully charged, the charging of the battery system 118 (including each of the other battery modules 204) is terminated. Thus, the remaining battery modules 204 may not reach full-charge condition. This results in the battery system 118 as a whole having less than its full capacity of charge when the charging cycle is terminated. In some cases, this can result in a significant reduction in available charge from the battery system 118. In this regard, various examples of the battery system charge level management system and method described herein mitigate the reduction in available charge when charging is complete and allow the battery system 118 to achieve a more complete charge level.

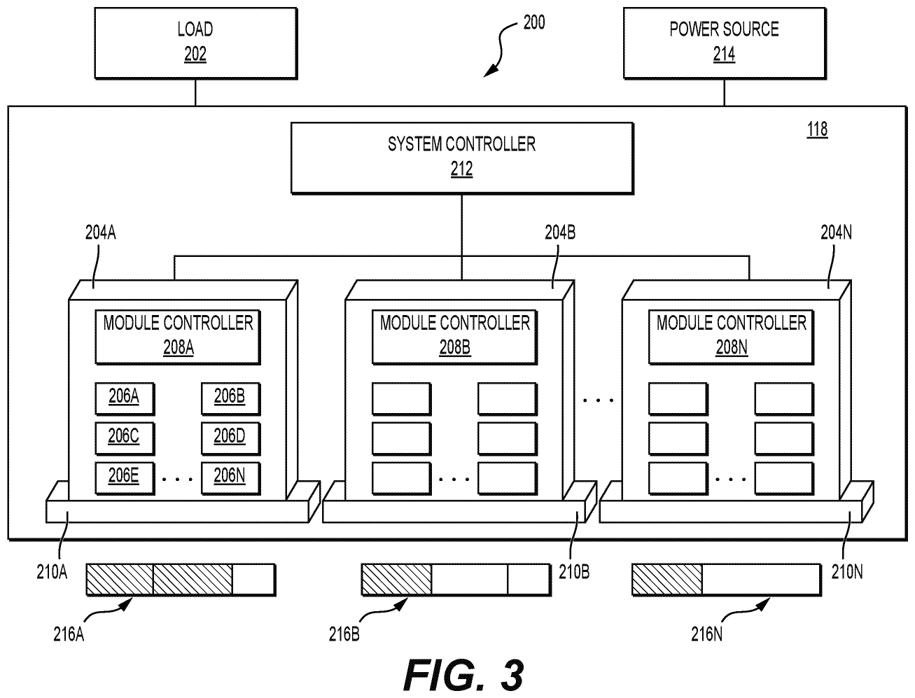

FIG. 3 is a schematic illustration of the battery system of FIG. 2, illustrating charge levels 216A-216N of the battery modules 204A-204N during a charge cycle. As noted above, if one battery module 204 becomes fully charged, the charging of the battery system 118, including the remaining battery modules 204, is terminated. In accordance with the various examples of the present disclosure, the system controller 212 monitors the charge level 216 of each battery module 204 during the charge cycle. The system controller 212 can determine that the charge level 216A of one battery module 204A is out of balance with the charge level 216B of at least one other battery module 214B. For example, as illustrated in FIG. 3, when the charge level 216A of the first battery module 204A (e.g., 70%) is significantly greater than the charge level 216B of the second battery module 204B (e.g., 40%), the system controller 212 can determine that the charge level 216A of the first battery module 204A is out of balance with the charge level 216B of the second battery module 204B. The determination of an out-of-balance state is made by the system controller 212 if the charge level 216A of the first battery module 204A is greater than the charge level 216B of the second battery module 204B by a predetermined amount.

In some examples, the predetermined amount may be a percentage of the charge-level capacity of the first battery module 204A. For example, if the capacity of the first battery module 204A is 100 KWh, the predetermined amount may be 10 percent of the capacity, or 10 KWh. Thus, if the charge level 216A of the first battery module 204A during the charge cycle exceeds the charge level 216B of the second battery module 204B by 10 KWh, the system controller 212 may determine that the charge levels are out of balance.

In other examples, the predetermined amount may be a percentage of the current charge level 216A of the first battery module 204A. For example, if the charge level 216A of the first battery module 204A during the charge cycle is 70 KWh, the predetermined amount may be 10 percent of the current charge level 216A, or 7 KWh. Thus, if the charge level 216A of the first battery module 204A during the charge cycle exceeds the charge level 216B of the second battery module 204B by 7 KWh, the system controller 212 may determine that the charge levels are out of balance.

In the example of FIG. 3, the out-of-balance condition is based on a comparison of the first battery module 204A and the second battery module 204B. In accordance with various examples of the present disclosure, the system controller 212 can determine an out-of-balance condition based on a comparison of any two battery modules 204 in the battery system 118.

In one example, the system controller 212 compares the battery modules 204 with the highest charge level and the lowest charge levels at regular intervals during the charge cycle. When the difference between the highest charge level and the lowest charge level exceeds a predetermined amount, the system controller 212 determines that an out-of-balance condition exists.

Upon determination that the charge level of one battery module (e.g., the charge level 216A of the first battery module 204A) is out of balance with the charge level of another battery module (e.g., the charge level 216B of the second battery module 204B), the system controller 212 causes the battery module 204A to power the thermal mat 210A thermally coupled to the battery module 204A. In other examples, the system controller 212 can cause the battery module 204A to power any one or more of the thermal mats 210A-210N.

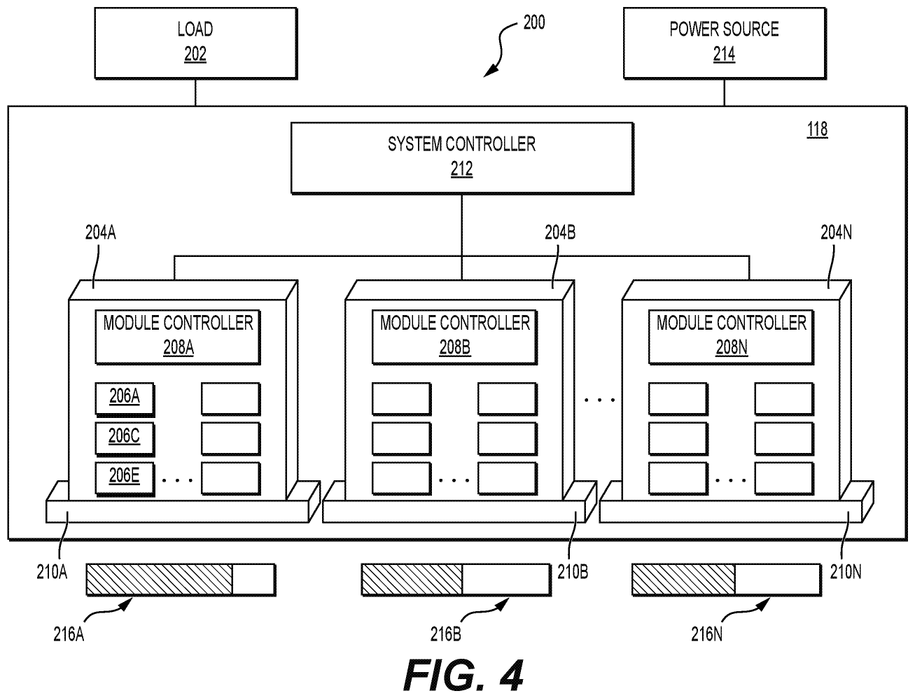

Using the battery module 204A with the highest charge level to power one or more thermal mats 210A-210N causes the battery module 204A to discharge or dissipate power. Thus, powering one or more thermal mats 210A-210N can cause the battery module 204A with the highest charge level to reduce its charge level 216A or decrease the rate of charging during the charge cycle. Reducing the charge level 216A or decreasing the rate of charging can allow the charge level 216B of the other battery module 204B to decrease the difference in the charge levels 216A, 216B, as illustrated by the charge levels 216A-216N of FIG. 4. In one example, along with charge balancing of the modules 204, the system can perform cell balancing within each module 204 by balancing the charge levels among the various cells 206 within each module 204 using the module controller 208 of each module 204.

In various examples, the system controller 212 implements a safety feature by limiting the temperature of the battery module 204. In this regard, if the system controller 212 determines that the temperature of a battery module 204 has exceeded a predetermined temperature threshold, the system controller 212 discontinues powering of the thermal mat 210 associated with that battery module 204. In this regard, if the temperature of a battery module 204 exceeds the predetermined temperature threshold, the system controller 212 prioritizes safety over mitigation of an out-of-balance charge condition.

### INDUSTRIAL APPLICABILITY

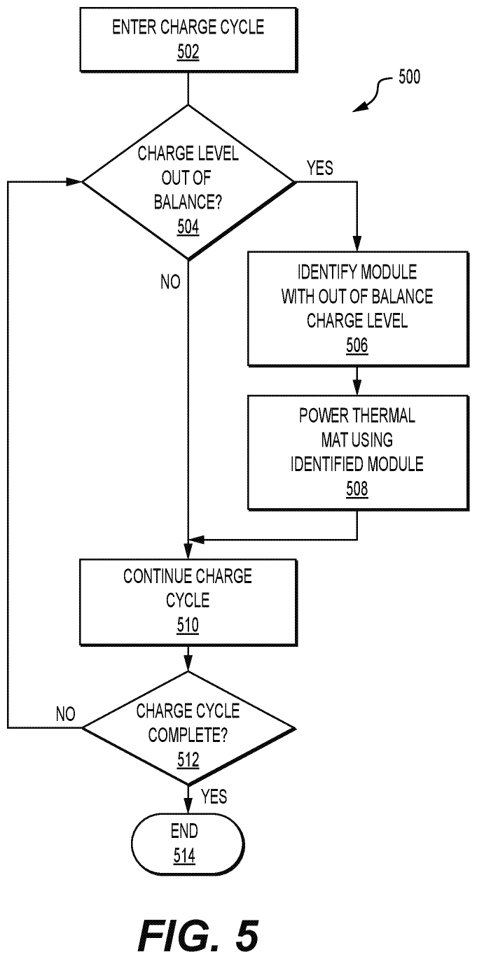

FIG. 5 is a flowchart illustrating a method 500 of managing charge levels of battery modules in a battery system used to power systems of a work machine, according to examples of this disclosure. The method 500 may be implemented by the system controller 212 for operation on the battery system 118 described above with reference to FIGS. 2-4.

At block 502, the battery system 118 enters a charge cycle. As described above, during a charge cycle, the battery system 118 is coupled to an external power source, such as an external battery, a generator, the electrical grid, or another electrical source. During the charge cycle, the battery system 118, including the battery modules 204 therein, are provided with electrical energy to increase the charge level of the battery system 118 as a whole and the individual battery modules 204.

At block 504, the system controller 212 determines whether a charge level 216 of a battery module 204 in the battery system 118 is out of balance with the charge level 216 of one or more of the other battery modules 204. As noted above, the out-of-balance condition may be determined if the charge level of one battery module exceeds the charge level of another battery module by a predetermined amount. If no out-of-balance condition exists, the method proceeds to block 510, and the charge cycle continues.

On the other hand, if an out-of-balance condition is determined at block 504, the method 500 proceeds to block 506. At block 506, the system controller 212 identifies a battery module 204 that is out of balance. In this regard, the system controller 212 may identify the battery module 204 with the highest charge level during the charge cycle as the battery module that is out of balance.

At block 508, the system controller 212 causes the identified battery module 204 to power one or more thermal mats. In one example, the identified battery module 204 is used to power the thermal mat associated with the identified battery module 204. In other examples, the identified battery module 204 is used to power thermal mats coupled to one or more of the other battery modules 204. The powering of the thermal mats using the identified battery module 204, or the battery module with the highest charge level, results in reduction of the power level or the rate of charging of the identified battery module 204. The method proceeds to block 510, and the charge cycle continues.

At block 512, the system controller 212 determines whether the charge cycle is complete. Completion of the charge cycle may be indicated by complete charging of one or more of the battery modules 204 of the battery system. If the charge cycle is determined to be not complete, the method returns to block 504. If the charge cycle is determined to be complete, the method ends at block 514.

The present disclosure describes example systems and methods mitigating the reduction in available charge for a battery system that may result from out-of-balance charge levels during a charging cycle. Various examples of the present disclosure provide a more complete charging of the battery system during the charge cycle.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system, comprising:
a first battery module and a second battery module;
at least one thermal mat being in thermal contact with at least one battery module;
a controller configured to, during a charge cycle:
determine that a charge level of the first battery module is out of balance with a charge level of the second battery module; and
cause a thermal mat to be powered by the first battery module.

2. The system of claim 1, wherein the charge level of the first battery module is out of balance with the charge level of the second battery module when the charge level of the first battery module is greater than the charge level of the second battery module by a predetermined amount.

3. The system of claim 2, wherein the predetermined amount is a percentage of a charge-level capacity of the first battery module.

4. The system of claim 2, wherein the predetermined amount is a percentage of the charge level of the first battery module.

5. The system of claim 1, wherein the thermal mat powered by the first battery module is thermally coupled to the first battery module.

6. The system of claim 1, wherein power to the thermal mat is discontinued when a temperature of a first battery module thermally coupled to the thermal mat exceeds a predetermined temperature threshold.

7. The system of claim 1, wherein each of the first battery module and the second battery module comprises a plurality of battery cells.

8. A work machine, comprising:
an electric motor; and
a battery system powering the electric motor, the battery system comprising:
a plurality of battery modules, each battery module comprising a plurality of battery cells;
a plurality of thermal mats, each thermal mat in thermal contact with and powered by an associated battery module of the plurality of battery modules; and
a battery system controller configured to, during a charge cycle, cause a selected thermal mat of the plurality of thermal mats to be powered by the associated battery module to discharge the associated battery module when the thermal controller determines a charge level of the associated battery module is out of balance with at least one other battery module of the plurality of battery modules.

9. The work machine of claim 8, wherein the charge level of the associated battery module is out of balance with the at least one other battery module when a charge level of the associated battery module is greater than a charge level of the at least one other battery module by a predetermined amount.

10. The work machine of claim 9, wherein the predetermined amount is a percentage of a capacity of the associated battery module.

11. The work machine of claim 9, wherein the predetermined amount is a percentage of the charged level of the associated battery module.

12. The work machine of claim 8, wherein power to the selected thermal mat is discontinued when a temperature of the associated battery module exceeds a predetermined temperature threshold.

13. The work machine of claim 8, wherein each battery module comprises a module controller configured to facilitate balancing of the plurality of battery cells within the battery module.

14. A method, comprising:
starting a charge cycle for a battery system having a plurality of battery modules, each module being in contact with and powering a corresponding thermal mat;
determining that a charge level of a first battery module of the plurality of battery modules is out of balance with a second battery module of the plurality of battery modules;
causing the first battery module to power the thermal mat corresponding to the first battery module to discharge the first battery module.

15. The method of claim 14, wherein the charge level of the first battery module is out of balance with the charge level of the second battery module when the charge level of the first battery module is greater than the charge level of the second battery module by a predetermined amount.

16. The method of claim 15, wherein the predetermined amount is a percentage of a charge-level capacity of the first battery module.

17. The method of claim 15, wherein the predetermined amount is a percentage of the charge level of the first battery module.

18. The method of claim 14, wherein power to the first thermal mat is discontinued when a temperature of the first battery module exceeds a predetermined temperature threshold.

19. The method of claim 14, wherein each of the first battery module and the second battery module comprises a plurality of battery cells.

20. The method of claim 14, wherein each battery module comprises a module controller configured to facilitate balancing of the plurality of battery cells within the battery module.
